(19) United States
(12) Patent Application Publication
(10) Pub. No.: US 2024/0241925 A1
(43) Pub. Date: Jul. 18, 2024

(54) METHOD AND SYSTEM FOR MATCHING CONTRACTS BETWEEN AUTOMOTIVE DATA PROVIDERS AND AUTOMOTIVE DATA CONSUMERS

(71) Applicant: OTONOMO TECHNOLOGIES LTD., Herzeliya Pituach (IL)

(72) Inventor: Amir FRUEND, Modi'in (IL)

(73) Assignee: OTONOMO TECHNOLOGIES LTD., Herzeliya Pituach (IL)

(21) Appl. No.: 18/154,980

(22) Filed: Jan. 16, 2023

(51) Int. Cl. G06F 18/22; G06Q 30/0202

(52) U.S. Cl. CPC G06F 18/22; G06Q 30/0202

(57) ABSTRACT

A method and a system for matching contracts between automotive data providers and consumers are provided herein. The method may include the following steps: obtaining a plurality of automotive data records and storing in a data store; obtaining data consumers requirements from the data consumers; obtaining data providers requirements from the data providers; and applying a contract matching function to said data consumers requirements and said data providers requirements to yield contact matching between at particular data providers and data consumers.

### FIELD OF THE INVENTION

The present invention relates generally to a computerized automotive data marketplace, and more particularly, to processing automotive data of connected vehicles on same.

### BACKGROUND OF THE INVENTION

Prior to the background of the invention being set forth, it may be helpful to provide definitions of certain terms that will be used hereinafter.

The term “connected vehicle” or “connected car” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform preferably implemented on a cloud that enables a plurality of users (e.g. subscribers or consumers) to access and consume data originated by various data sources (e.g. data providers). Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces is used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

The term “data anonymization” as used herein is defined as type of information sanitization whose intent is privacy protection. It is the process of either encrypting or removing personally identifiable information from data sets, so that the people whom the data describe remain anonymous.

### SUMMARY OF THE INVENTION

Embodiments of the present invention provide method of matching contracts between automotive data providers and consumers. The method may include obtaining a plurality of automotive data contracts and storing them on a data lake; extracting legal and commercial terms from the automotive data contracts; applying a contract matching function to the: legal and commercial terms, data consumers and said data providers requirements to yield contract matching between a specified subset of said data consumers and a specified subset of said data providers. The system may implement the aforementioned method over an electronic automotive data marketplace.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating an architecture of one system in accordance with some embodiments of the present invention; and

FIG. 2 is a high-level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing” “calculating” “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

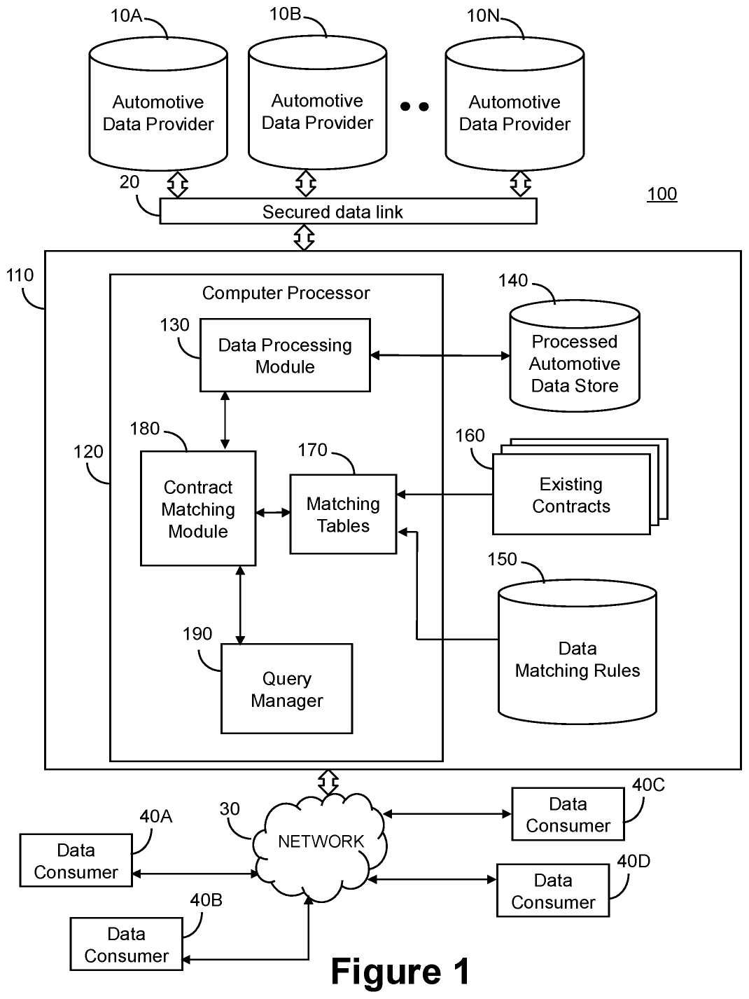

FIG. 1 is a block diagram illustrating non-limiting exemplary architecture of the system in accordance with some embodiments of the present invention. Automotive data distribution network 100 comprises at least one automotive data distribution server 110 which may, in preferable embodiments, be a secured automotive data server fully compliant with data protection and privacy regulations.

Server 110 may be implementing a data marketplace and connected via network 30 to a plurality of data consumers 40A-40D. Vehicle related data, possibly obtained from various sensors may be stored in raw format on a plurality of vehicle related data sources such as automotive data providers 10A-10N and are accessed by server 110 via a secured data link 20. Server 110 may include a data processing module 130 implemented by a computer readable code running on computer processor 120 that stores processed automotive data records on data store 140.

Existing contracts 160 between data consumers and data providers are stored on the data store and data matching rules are extracted from the existing contracts, so that data consumers requirements data providers requirements are formed into data matching rules 150.

In operation, contract matching module 180 applies contract matching function to said data consumers requirements and said data providers requirements to yield contract matching between at particular data providers and data consumers.

According to some embodiments of the present invention, the customer (data providers and data consumers) contracts include information that is key for any of the following: conforming with our customers privacy rules; keeping customers data rights; and matching between data providers and data consumers

According to some embodiments of the present invention, the overall system may include the following modules: data provider/data consumer (DP/DC) contract tables summarizing the main contract terms; DP/DC virtual contract tables to enable “What-If” scenarios; Contract table editor to enable populating the tables with data per each contract; DC Contract Generator enabling to generate a full DC contract based on DC Contract table to be used for self-onboarding; and Contract Matching module to enable identifying DC's that match DP requirements and vice versa.

According to some embodiments of the present invention, the contract tables may include information representing the contract terms as well as additional information based on existing data in the platform. This enables comparing signed terms with the contract implementation as well as matching based on actual vs. planned.

According to some embodiments of the present invention, each table is identified by: Provider/Consumer ID Agreement ID, enabling multiple agreements per provider/consumer Dataset ID, relevant to providers only, enabling multiple data sets covered by one agreement.

According to some embodiments of the present invention, the system may further provide at least one of: hypothetical demand and hypothetical supply to the contract matching function and outputting hypothetical matching between data providers and data consumers.

According to some embodiments of the present invention, the system may further include a recommendation engine which generates recommendations for altering at least one of: demand by the data consumers and supply by the data providers in order to improve contract matching level between subset of the data consumers and a subset of the data providers.

According to some embodiments of the present invention, the contract matching may include applying a scoring function that assigns a score to each of the matches between the data providers and the data consumers, based on predefined criteria.

According to some embodiments of the present invention, the contract matching may include applying matching tables 170 to contract matching module 180 wherein matching tables 170 indicate demand and supply for each of the data provider and the data consumers.

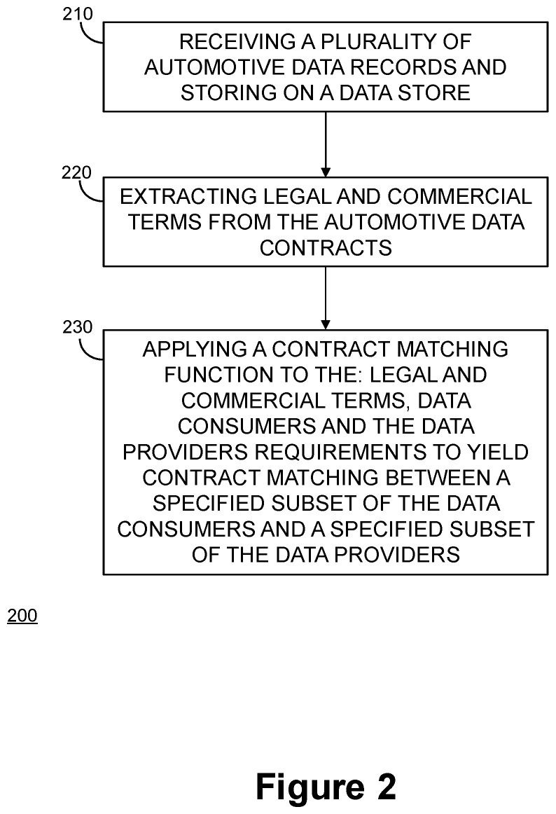

FIG. 2 is a high-level flowchart illustrating non-limiting exemplary method in accordance with embodiments of the present invention. A method 200 of matching contracts between automotive data providers and consumers is provided herein. The method may include the following steps: obtaining a plurality of automotive data contracts and on a data lake/data store 210; extracting legal and commercial terms from the automotive data contracts 220; applying a contract matching function to said: legal and commercial terms, data consumers and said data providers requirements to yield contract matching between a specified subset of said data consumers and a specified subset of said data providers 230.

To implement method 200 according to embodiments of the present invention, a computer processor may receive instructions and data from a read-only memory or a random-access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of matching contracts between automotive data providers and automotive data consumers, the method comprising:
receiving a plurality of automotive data records and storing in a data store;
receiving data consumers requirements from the data consumers;
receiving data providers requirements from the data providers; and
applying a contract matching function to said data consumers requirements and said data providers requirements, to yield potential contract matching between at least some of the data providers and at least some of the data consumers,
wherein the receiving and the applying are carried out by a computer processor.

2. The method according to claim 1, further comprising providing at least one of: hypothetical demand and hypothetical supply to the contract matching function and outputting hypothetical matching between data providers and data consumers.

3. The method according to claim 1, further comprising generating recommendations for altering at least one of: demand by the data consumers and supply by the data providers in order to improve contract matching level between subset of the data consumers and a subset of the data providers.

4. The method according to claim 1, wherein said contract matching comprises applying a scoring function that assigns a score to each of the matches between the data providers and the data consumers, based on predefined criteria.

5. The method according to claim 1, wherein said contract matching comprises applying tables indicating demand and supply for each of the data provider and the data consumers.

6. A system for matching contracts between automotive data providers and automotive data consumers, the system comprising:
an electronic automotive data marketplace which obtains a plurality of automotive data records and storing in a data store;
a data processing module and a query manager which obtain data consumers requirements from the data consumers and obtains data providers requirements from the data providers; and
a contract matching module which applies contract matching function to said data consumers requirements and said data providers requirements to yield contract matching between at particular data providers and data consumers.

7. The system according to claim 6, further comprising providing at least one of: hypothetical demand and hypothetical supply to the contract matching function and outputting hypothetical matching between data providers and data consumers.

8. The system according to claim 6, further comprising a recommendation engine which generates recommendations for altering at least one of: demand by the data consumers and supply by the data providers in order to improve contract matching level between subset of the data consumers and a subset of the data providers.

9. The system according to claim 6, wherein said contract matching comprises applying a scoring function that assigns a score to each of the matches between the data providers and the data consumers, based on predefined criteria.

10. The system according to claim 6, wherein said contract matching comprises applying tables indicating demand and supply for each of the data provider and the data consumers.

11. A non-transitory computer readable medium for matching contracts between automotive data providers and automotive data consumers, the computer readable medium comprising a set of instructions that when executed cause at least one computer processor to:
receive a plurality of automotive data records and storing in a data store;
receive data consumers requirements from the data consumers;
receive data providers requirements from the data providers; and
apply a contract matching function to said data consumers requirements and said data providers requirements, to yield potential contract matching between at least some of the data providers and at least some of the data consumers.

12. The non-transitory computer readable medium according to claim 11, further comprising providing at least one of: hypothetical demand and hypothetical supply to the contract matching function and outputting hypothetical matching between data providers and data consumers.

13. The non-transitory computer readable medium according to claim 11, further comprising generating recommendations for altering at least one of: demand by the data consumers and supply by the data providers in order to improve contract matching level between subset of the data consumers and a subset of the data providers.

14. The non-transitory computer readable medium according to claim 11, wherein said contract matching comprises applying a scoring function that assigns a score to each of the matches between the data providers and the data consumers, based on predefined criteria.

15. The non-transitory computer readable medium according to claim 11, wherein said contract matching comprises applying tables indicating demand and supply for each of the data provider and the data consumers.
